(19) United States
(12) Patent Application Publication
(10) Pub. No.: US 2014/0113683 A1
(43) Pub. Date: Apr. 24, 2014

(54) Mobile Key Identification

(71) Applicant: Robert L. Hickey, Charlevoix, MI (US)

(72) Inventor: Robert L. Hickey, Charlevoix, MI (US)

(21) Appl. No.: 14/061,237

(22) Filed: Oct. 23, 2013

Related U.S. Application Data
(60) Provisional application No. 61/717,151, filed on Oct. 23, 2012.

(51) Int. Cl. H04M 1/21; G06F 17/30; G06K 9/00

(52) U.S. Cl. CPC H04M 1/21; G06K 9/00577; G06F 17/30259
USPC 455/556.1

(57) ABSTRACT

A key recognition method and apparatus for use on a smartphone or similar. The viewfinder display for the phone's image sensor is provided with a registration mark or icon adapted to help align and register the image of a flat key being viewed through the image sensor. An image-recognition process running on the phone is used to capture and convert the key's image to an image file stored on the phone, and the user is prompted to enter identifying information for association with the image file. When an unknown key is found, it can be viewed through the image sensor, displayed on the viewfinder screen, registered in the registration icon, and compared by the image-recognition process to previously-stored key images to try and find a match.

### RELATED APPLICATIONS/PRIORITY BENEFIT CLAIM

This application claims the benefit of U.S. Provisional Application No. 61/717,151, filed Oct. 23, 2012 by the same inventor (Hickey), the entirety of which provisional application is hereby incorporated by reference.

### FIELD

The subject matter of the present application is in the field of imaging and identifying keys.

### BACKGROUND

Many people accumulate a large number of keys, and very few people take the trouble to individually label their keys for later identification (house, cottage, garage, office, file cabinet, desk drawer, padlock, front door, back door, etc). It is common over time for a person to have in his possession unlabeled keys whose purpose is no longer remembered.

One approach to storing key information for later identification or replacement is the “Key Gauge” mobile phone software application (app) commercially available from Factory Brands Ltd, LLC via the iTunes® App Store, for downloading and use on the iPhone mobile phone . The Key Gauge app helps determine a key number from certain popular brands of key (e.g. Schlage and Kwikset) using the display screen on a smartphone such as the iPhone. Using the iPhone's high-resolution touchscreen display, the Key Gauge app shows the user actual size images of popular keys in their uncut, blank form. A virtual key cut gauge comprising an array of virtual dials is displayed next to the key image, and the key bitting of the user's actual key can be dialed in using a finger or stylus or cursor to select numbers corresponding to key cut depths. As the numbers are dialed, arrow-shaped “cut” icons aligned with the respective dials are moved more or less deeply into the key blade image to visually simulate a cut, changing the image on the screen to match the actual key. Once the image on the screen matches the actual key, as determined visually by the user, the app prompts the user to store the dialed key number, manufacturer stamping notation, and notes such as the user's name for the key (“front door”, “garage”, “cabin”, etc.) along with the dialed image.

It is believed that the stored key information in the Key Gauge app is stored in the phone's memory, although it would be possible to store the information off-phone, for example in the app provider's database, on a personal computer, or on a portable data storage device such as a flash drive. For example, the Key Gauge app allows a table of key numbers, key stamps and user notes to be emailed out of the application as a CSV file at any time.

A disadvantage of the Key Gauge app is its reliance on the user's visual estimation of a match between the dial-altered key image on the phone's display and the actual key in order to generate a storable image. The app is also limited to a set of popular key types from certain manufacturers. The app also appears to require a visual comparison by the user between an unidentified key and a stored key image.

It is also known to use mobile phone apps for general image recognition via a phone's image sensor, in which an image captured by the image sensor is compared to an image library stored on the phone or on a remote PC or server. When a match is found, the user is notified of the result by voice or display. Examples include LookTel™ smartphone object recognition for Windows Mobile smartphones; the IBM SAPIR™ image-recognition app, which operates without the need for a keyword tag on the image file; the Vuforia™ image recognition app by Qualcomm Incorporated, which performs image recognition against a local database on the phone of up to eighty images, and against a cloud-based database of up to a million images, to aid shoppers in obtaining product information and reviews; and Gaziru™ image recognition service by NEC, which compares images captured by the smartphone with saved image data, and displays the names and details of the objects on the screen.

### BRIEF SUMMARY

I have invented a method and apparatus for identifying once-known keys that have become unknown, using a portable data and imaging device having a built-in camera or other image sensor, a high resolution screen, and a screen-based virtual viewfinder or similar display. These data and imaging devices include, but are not limited to, mobile phones, portable computer and display devices such as the iPad® tablet computer, and smartphones such as the iPhone® series and equivalent devices. Such devices will hereafter be generically referred to as “smartphones”, or simply “phones”.

In a first aspect of the invention, the smartphone is modified to function as a key-identification device with a software application (app) downloaded into and stored in the phone's processor/memory in known manner. The virtual viewfinder on the phone's display screen, used to display and frame the image of an item for purposes such as scanning barcodes, or framing pictures being taken with the phone's built-in camera, is modified to include an image defining a visual registration mark. The visual registration mark is shaped and sized to visually mate with and register a static, registrable portion of a key image corresponding to a static, registrable portion of an actual key being viewed via the phone's image sensor and viewfinder, i.e. a portion of the key not modified when the key blank is cut, and thus with a shape that can be anticipated with an appropriately-shaped or -located mark. The registration mark is displayed on the screen as an electronic image independent of the key image received via the camera, and is fixed relative to the image of the key. Accordingly, the user moves the phone to register or align the key image to the registration mark.

In a preferred form, the visual registration mark corresponds to the outline of a portion of a key's tip, which tends to be fairly standard in shape among many brands of flat key. In some cases it might be preferable to use a different portion of the key for the registration mark, for example the key shoulder. It is possible to provide different registration marks for different styles or brands of key, where the tips or other registrable portions vary significantly.

Once the key image is registered, an image-capturing/recording process running on the phone (for example, the process for taking a picture of an imaged object with the phone camera) is activated to capture or record the image aligned with the registration mark to memory, for example by “scanning” or recognizing some or all of the registered key's image using a known type of image-recognition process and capturing it to memory as an image file. The image file, unique to the user's self-identified key, is stored in the phone's memory for later comparison and retrieval. A data entry field is provided to name the key (house, office, garage, etc.), and the name is associated with the key image file in the phone's memory for later matching and retrieval. In a preferred form, for security purposes, the image file is stored in a manner that is not retrievable in human-readable form, but remains accessible to an image-recognition/comparison process.

The apparatus further includes an image-recognition process or app, capable of running on the mobile phone and comparing the image of an unknown key registered with the mark on the screen to stored key image files in the phone memory; to find a match; and, to display a match notification on the screen.

In a method aspect of the invention, a mobile phone is used to store and retrieve key information by: temporarily displaying a key registration mark on the phone's viewfinder screen display; registering the image of an actual, known key being viewed in the viewfinder with the visual registration mark on the screen; recognizing or capturing the registered key image; and storing data representing at least an identifying part of the recognized/captured key image as an image file in the phone memory with identifying data such as a key name. In a further aspect of the method, the image of an unknown key viewed via the viewfinder is registered with the mark on the viewfinder, and the unknown key image is compared to previously-recorded known key image files in the phone memory to find a match, and to provide a match notification on the screen.

The method for “scanning” the registered key image displayed on the screen, i.e. for recognizing and/or capturing it, can include or use any algorithm, process, or app, capable of running on the processor of a mobile phone, for recognizing an electronically-displayed image of a relatively flat item such as a key being viewed on the screen, and for converting the recognized image to image data that can be stored as an image file on the phone memory. The method for comparing an imaged, unknown key to a previously stored key image can include or use any algorithm, process, or app, capable of running on the processor of a mobile phone, for comparing images or for comparing data representing images.

These and other features and advantages of the invention will become apparent from the detailed description below, in light of the accompanying drawings.

### BRIEF DESCRIPTION OF THE DRAWINGS

FIG. 1 is a perspective view of a schematically represented smartphone type mobile phone, positioned with its camera facing a key lying on a flat surface.

FIG. 2 is a front view of the mobile phone of FIG. 1, with an image of the key displayed on the screen viewfinder, and with a registration mark displayed on the screen viewfinder.

FIG. 3 is similar to FIG. 2, with the addition of a data entry field for key-identifying information displayed on the screen.

FIG. 4 is a schematic block representation of a method for imaging and registering a known key using the mobile phone of FIG. 1, and for storing known key image and associated identifying information in the phone's memory.

FIG. 5 is similar to FIG. 4, with the addition of a schematic block representation of a method for imaging and registering an unknown key using the mobile phone of FIG. 1, and for comparing the image of the unknown key to known key image information in the phone's memory, and for providing a match notification on the screen.

FIG. 6 is similar to FIG. 3, with the modification that an unknown key image is displayed and registered on the screen, along with a match request field.

FIG. 7 is similar to FIG. 6, with the match request field replaced with a match notification.

### DETAILED DESCRIPTION

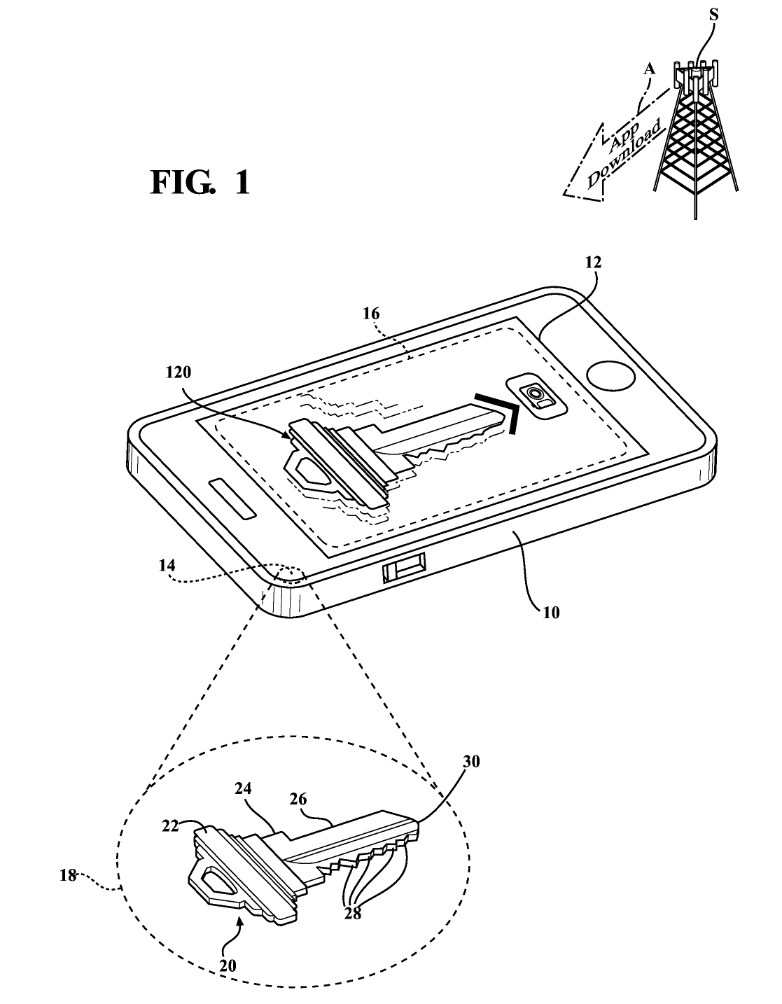

Referring first to FIGS. 1 through 3, a smartphone 10 is shown in exemplary form in order to teach how to make and use the claimed invention. Smartphone 10 represents a generic example of known, commercially available phones such as the Apple iPhone®, Windows Mobile®, Motorola Droid®, Blackberry®, and others, without limitation, capable of imaging an object through an image sensor, capturing or recording the image, storing the image in a retrievable memory resident on the phone as image file data, and downloading and running a mobile image-recognition software application locally on the phone. As such, phone 10 will generally have one or more internal microprocessors or controllers with associated volatile and non-volatile memory (flash, ROM, various forms of RAM, SD cards, etc.) and running a commercially available operating system; battery power; antenna; LCD or similar touchscreen; camera or other image sensor; data/communication ports; a data entry interface such as a keypad (or virtual keypad through the touchscreen); microphone and speaker; SIM card or equivalent; high speed data access via WiFi or mobile broadband, including internet browsing capability; and other features and functions known to those skilled in the art.

The exact structure of phone 10 is not critical to the present invention, provided the phone is capable of viewing and imaging an image through a viewfinder (typically a virtual viewfinder on the display touchscreen), recognizing or capturing the image in a manner allowing the image to be stored as an image file in the phone's non-volatile memory, and running an image-processing/recognition app on its processor in coordination with the captured images previously viewed on the screen and stored in memory.

Illustrated phone 10 includes a display screen 12, for example an LCD touchscreen, sufficiently large to display the image of a key with reasonable clarity to a user; an electronic image sensor 14 of known type used for purposes such as image recognition, scanning or taking pictures, with sufficiently high resolution to distinguish and image the details of a key, particularly the blade and bitting; and a “viewfinder” 16, comprising a portion of the display screen 12 temporarily enabled in known manner to display the objects in a field of view 18 of image sensor 14.

FIG. 1 also shows a typical flat key 20 in the field of view 18, and a corresponding key image 120 displayed on the viewfinder 16. Key 20 is a representative example of the type of flat key for which the invention is adapted, comprising a bow or head 22, a shoulder stop 24, a blade or shank 26, teeth or bitting 28 cut or milled into the blade, and a tip 30. Key 20 is of the type commonly used for residential door locks, file cabinets, and padlocks, without limitation, and is usually made from metal such as steel, bronze, or aluminum.

While most keys have shoulder stops to control how much of a key blade enters a lock, and to align a key and a key blank in a key machine for the tracing and cutting process, some do not, and instead rely on the tip to align a key. Both the tip and shoulder stop therefore make good registrable portions of the key for a scanning/recording process. For purposes of this description, the tip will be used for the registrable portion.

FIG. 1 also schematically illustrates the wireless download of a software application or app A from a service provider S, for example a wireless service provider through which a user subscribes for phone service, mobile internet access, and related services including the download of apps from the service provider or from app stores on the Internet. App A is an image-recognition app capable of recognizing distinguishing detail on an item viewed through image sensor 14 and imaged on screen 12, such as a key, and of capturing, storing, and/or comparing that image against a library of images or image files stored in the phone's memory. App A need not perform the capturing and storing image functions, which may be performed by other software or programming common to such phones, but it should be able to scan/recognize and compare such phone-captured images to other images or image files. As such, app A may be for example a known, commercially-available image recognition app modified to run such comparisons as follows.

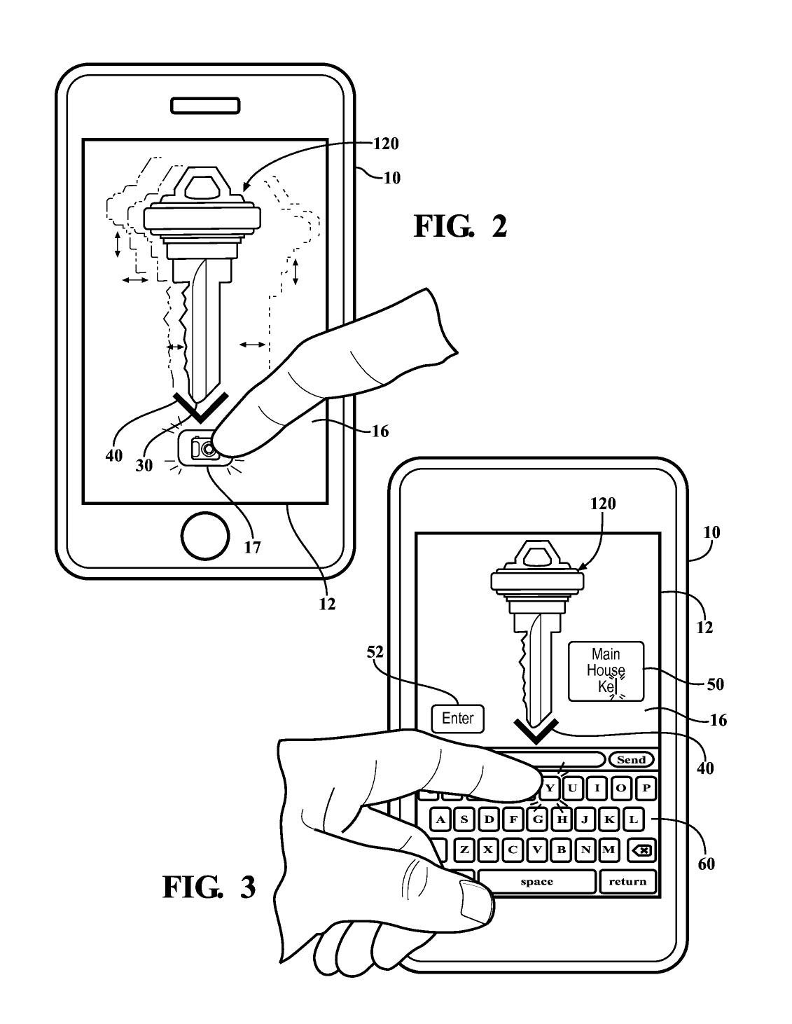

FIG. 2 illustrates phone 10 from the front, as would be perceived by a user viewing the key 20 through image sensor 14. Key image 120, an accurate, high resolution image of key 20, is displayed on viewfinder display 16, and moves around the display (represented in phantom lines) as the user moves the phone 10 relative to key 20. In accordance with the invention, viewfinder display 16 is modified with a registration mark 40, comprising an electronic image displayed in viewfinder 16 in a location determined to register a suitable portion of the key, e.g. the shoulder stop 24 or the tip 30. The registration mark is preferably an outline or partial outline of the portion of the key being registered. The registration mark could alternately by a discontinuous array of lines, points, dashes, icons or the like, without limitation, for locating peripheral portions of the key; or it could comprise any other image or shape (or combinations of images or shapes) that helps align and register a suitable portion of the key. In the illustrated example of FIG. 2, registration mark 40 is a generally V-shaped image approximating the outline of a key tip. It is also possible to supplement the V-shaped registration mark 40 with lines, points, dashes, etc., for example vertical lines parallel to or through the vertical axis of the key.

Since different key blanks are used for different types and sizes of keys, and since similarly sized keys from different makers might have differently-shaped or sized tips 30, it is possible to provide a choice of registration marks 40 for display on screen 12, for example stored as selectable image or icon files, selected by the user based on visual comparison to the key being viewed, or by association with keys cut from particular blanks or made by particular manufacturers.

FIG. 2 schematically shows key image 120 in motion (phantom lines) as the user moves the phone 10 to register the tip 30 with mark 40. Once tip 30 is registered in mark 40, the registered image 120 may be captured or “scanned” manually by the user, for example by pressing the phone control 17 for taking a photo after visually estimating proper registration, or pressing another button or control (for example a touchscreen “capture/scan” icon) after a prompt from the app if the image-recognition process determines when the key is registered relative to mark 40. Image 120 may also be recognized or captured automatically by the app without additional user input if the app's image-recognition process determines proper registration or alignment with mark 40. The capturing of the image 120 may fix the image in place on the screen, or it may instantaneously store the key image as an image file in memory, or it may do both. For convenience, this recognizing of the registered image as a key and capturing the image (or recognition-friendly portions thereof) for storage to memory can be referred to as a “scan,” however performed.

FIG. 3 shows the registered, captured image 120 fixed in place on the screen, along with a prompt for the user to enter identifying information for that key. Identifying information could also be entered without the key image being displayed or frozen on the screen, for example after the key image data has been instantly stored in an image file, but in the illustrated example it is preferred to keep the key image captured on the screen to assist the user in associating the identifying data directly with the image of the key. In the illustrated example, a data entry field 50 is displayed next to the key image, and a user interface (e.g., a keypad) 60 is enabled for the user to enter information such as, but not limited to, a key name, and user notes about the key's identity and purpose. For example, the user could type in “main house key—doorknob, not deadbolt”. Once the identifying information is filled out in field 50, the user may then enable the process of app A to scan and record the image 120 as an image file in the phone memory, if not already done, for example via an “enter” button 52 displayed on the touchscreen 12. Alternately, if the key image file has already been created and stored, pressing “enter” may simply tag the image file with identifying information about the key.

The registration of key image 120 relative to mark 40 is significant because it helps an image recognition process running on the phone to scan or otherwise distinguish and recognize the details of the key image, for example the outline of the bitting or teeth along the blade, and to create an accurate, comparison-ready image file of those details.

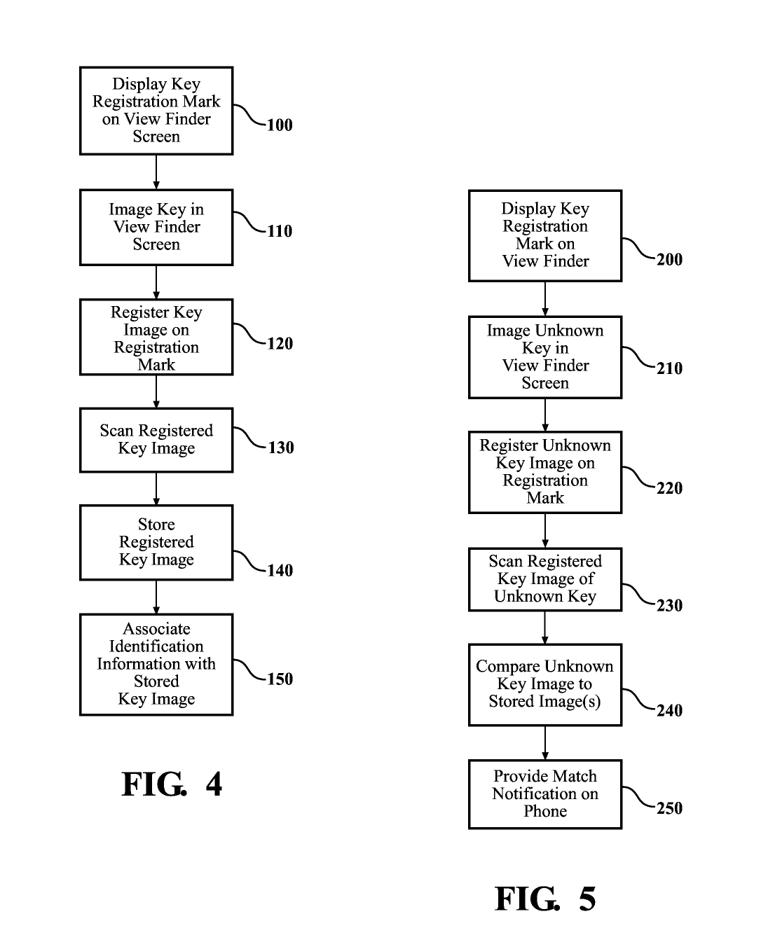

FIG. 4 schematically illustrates the process described above for displaying registration mark 40 on the viewfinder display (block 100), for example in response to the key-recognition app being enabled on the phone by the user; for viewing and displaying the key image 120 in the viewfinder display (block 110); for registering the key image 120 relative to mark 40, by moving the phone 10 relative to key 20 until the image is registered (block 120); for capturing or scanning the registered key image (130) and storing it in memory (140) as a comparison-ready image file; and for associating identifying information with the stored key image file (block 150). It will be understood that while the block diagram is a currently preferred representation of the process, the order in which these steps are implemented may vary, and some steps may be combined with others.

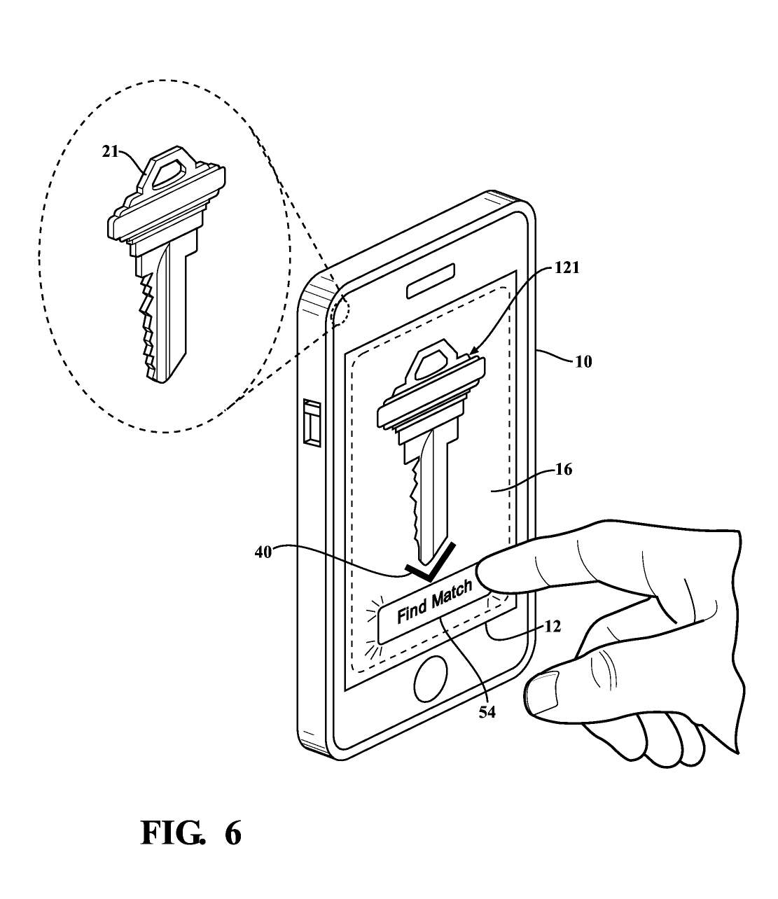

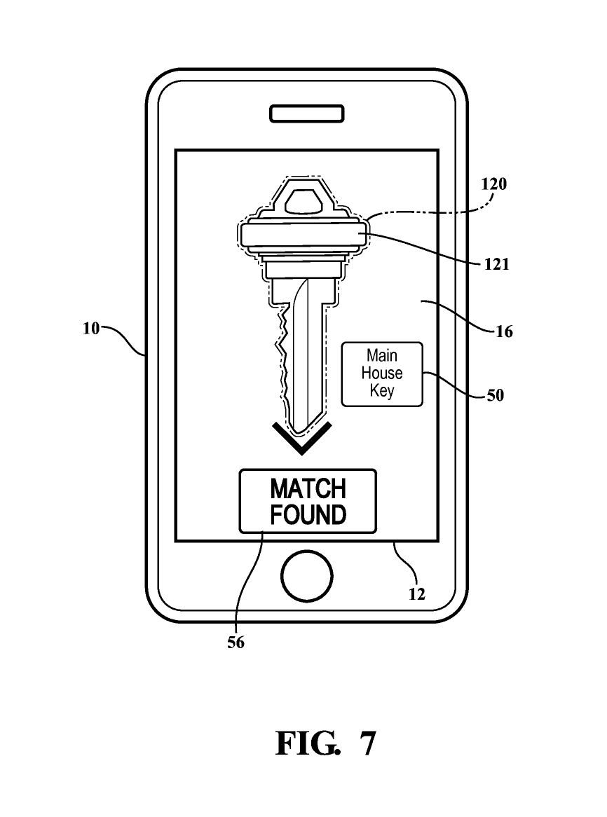

FIG. 5, supplemented by FIGS. 6 and 7, schematically illustrates a second process according to the invention, wherein the phone's user finds an unknown key 21 and wants to see whether he may have previously recorded its image and identifying information in the phone's memory. At block 200, registration mark is displayed on the viewfinder screen 16 in response to the key-recognition app being activated by the phone's user. At block 210, the unknown key 21 is viewed through the phone's image sensor 14, and its image 121 is displayed on the viewfinder screen 16. At block 220, the unknown key image 121 is registered in mark 40 on the viewfinder screen. At block 230, the registered image 121 of the unknown key is captured and scanned or converted into a comparison-ready image file. At block 240, the unknown key image file is compared to stored key images in the phone memory using the image-recognition process (FIG. 6). At block 250, a match notification is provided to the user, for example by a visual notification on screen 12, by an audible alert, or both (FIG. 7).

A match notification may be positive if a match is found, or negative if the unknown key 21 has not been previously scanned and stored in the phone memory as a known, identified key.

FIG. 6 shows the unknown key 21 being viewed through the phone image sensor 14, and its image 121 displayed on viewfinder portion 16 of screen 12 in registration with mark 40. When the image 121 is registered with mark 40, the user is prompted to enable the image-recognition process to compare unknown key image 121 (or representative data or files) with known key image 120 (or its representative data or image file) stored in an image library in the phone's memory. The prompt may take different forms, but in the illustrated example is a touchscreen icon/button “find match”.

FIG. 7 shows the results of the image-recognition process comparison performed in FIG. 6, in which the image-recognition process has determined that image 121 is a match for previously-stored image 120. One or more display notifications are given to the user on the phone 10, for example an overlay 120 of image of known key 20 from the library over (or behind) the image 121 of the unknown key. Data field 50 associated with stored image 120 may also be displayed, giving the name of the key or other identifying information. As noted above, it might be preferred in some cases to compare the stored key image to the registered image of the unknown key without providing a human-readable image of the stored key on the screen, for security purposes.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention should accordingly be construed by what the above disclosure teaches and suggests to those skilled in the art, and by any claims that the above disclosure supports in this application or in any other application claiming priority to this application.

What is claimed:

1. An apparatus for storing key information and for comparing an unknown key to stored key information for the purpose of identifying the unknown key, comprising:
a mobile phone device including an image sensor, a viewscreen with a viewfinder portion for displaying images of objects sensed by the image sensor, a processor for running apps, and a memory for storing key information corresponding to a known key viewed with the image sensor and displayed on the viewfinder;
one or more apps running on the mobile phone device capable of temporarily modifying the viewfinder portion of the viewscreen with a key registration mark configured to correspond to and register at least a portion of a viewed known key image displayed on the viewfinder portion of the viewscreen, scanning or capturing a registered known key image displayed on the viewscreen, storing key data for a registered and scanned known key image in the phone memory, and comparing a registered unknown key image viewed with the image sensor and displayed on the viewfinder portion of the viewscreen with the key data for the known key image stored in memory.

2. The apparatus of claim 1, wherein the key registration mark is configured to correspond to and register a static, registrable portion of a viewed known key image displayed on the viewfinder portion of the viewscreen

3. The apparatus of claim 2, wherein the key registration mark is displayed on the viewfinder portion of the screen as an electronic image independent of the viewed key image.

4. The apparatus of claim 2, wherein the key registration mark corresponds to an outline of a portion of a key's tip.

5. The apparatus of claim 2, wherein the key registration mark corresponds to an outline of a portion of a key's shoulder.

6. The apparatus of claim 2, wherein a plurality of key registration marks are available in phone memory corresponding to different types or makes of key.

7. The apparatus of claim 1, further comprising a viewed image of a known key stored in local phone memory.

8. The apparatus of claim 7, further comprising means for associating known key identifying data with the viewed image of a known key stored in local phone memory.

9. The apparatus of claim 7, wherein the viewed image of a known key stored in local phone memory is not retrievable from memory in human-readable form.

10. A method for storing information on known keys and identifying unknown keys, comprising:
using a mobile phone image sensor to image a known key;
providing a registration mark on a viewscreen of the mobile phone;
registering at least a portion of the known key image with the registration mark;
capturing the registered known key image;
storing data representing at least a portion of the registered known key image to phone memory.

11. The method of claim 10, further comprising imaging an unknown key with the mobile phone image sensor; registering at least a portion of the unknown key image with the registration mark on the viewscreen; and comparing the unknown key image with the stored known key data.

12. The method of claim 11, further comprising providing a match notification from the comparison of the unknown key image to the stored known key data.
